(19) United States
(12) Patent Application Publication
(10) Pub. No.: US 2009/0188507 A1
(43) Pub. Date: Jul. 30, 2009

(54) Nasal Air Pillow Holder

(76) Inventor: Toni LaCava, Melbourne, FL (US)

Correspondence Address: JOEL I ROSENBLATT, 445 11TH AVENUE, INDIALANTIC, FL, 32903, US

(21) Appl. No.: 12/020,523

(22) Filed: Jan. 26, 2008

(51) Int. Cl. A62B 18/02

(52) U.S. Cl. 128/207.13; 128/206.21

(57) ABSTRACT

A holder for nasal pillow as used for respiration in the treatment of sleep apnea, is arranged to enclose the mask substantially continuously along its longitudinal axis or axial length, stabilizing the mask against the nose breathing passage openings. The holder is held in position by a soft, deformable, or flexible strap. The flexible strap, which conforms to the contour or shape of the wearer's face, directs the force holding the nasal pillow in place along the facial contour, without causing any deformation of the face tissue and sleep interfering discomfort.

### BACKGROUND

Masks are used for various reasons. Typically masks are interconnected with a source of breathable fluid to be inhaled by a patient. These masks are used for anesthesia and also for providing positive air pressure to a patient in the treatment of obstructive sleep apnea. In the treatment of obstructive sleep apnea, positive air pressure is provided to a patient while the patient is sleeping. Accordingly, in the treatment of obstructive sleep apnea, mask comfort is important to ensure that the patient may sleep and also to ensure that the patient complies with the treatment. For the treatment of obstructive sleep apnea, the mask must provide a sufficient seal to enable pressure to be maintained within the airway of the patient. Typical masks are bulbous and enclose a large portion of the nose and engage the face of the patient. These masks tend to produce a claustrophobic effect on the patient. Furthermore, these masks generally irritate the bridge of the nose and parts of the patient's face hindering patient comfort. Also, generally these masks are secured to a patient's head by straps to ensure that a tight seal is had, thus further presenting pressure onto the patient's nose. Additionally, the positioning and securing of the mask with the straps is cumbersome and time consuming.

Some masks have been developed which are neither bulbous nor fit on a patient's nose, but consist of a pair of elongated flange members which are inserted directly into the patient's nares. While this type of mask is suitable for its intended purpose, the presentation of air directly into the patient's nares is awkward and generally uncomfortable to the patient.

U.S. Pat. No. 7,178,528 Lau, discloses an adjustable, semi-rigid headgear for maintaining the proper positioning of a headgear for a noninvasive ventilation interface about a wearer's head and on the wearer's face, intended to prevent the kinking of medical gas tubing and to hold a nasal cannula in proper position as the wearer sleeps and/or changes their head's position.

U.S. Pat. No. 6,119,694 Correa, discloses a nasal mask assembly having a nares or nostril seal for enclosing the nares of a patient and a pair of lateral support members for engaging the cheekbones of a patient and supporting the nasal mask assembly for sleeping. An associated headgear assembly constructed of semi-rigid members is selectively interconnected for defining a headgear. The nasal mask assembly is interconnected with depending arms of the headgear assembly by contact connectors enabling the nasal mask to be adjusted linearly and angularly with respect to the headgear assembly. The headgear assembly, in combination with the contact connectors, enables the nares seal to be quickly and easily attached and detached should the patient need to remove the mask upon waking during the sleep period as well as reattached for subsequent sleeping. The lateral arms of the mask support removes any supporting force from the patient's nose and positions the force onto a bone structure which is more suitable for supporting the nare seal.

U.S. Pat. No. 6,938,620 Payne, Jr. discloses head wear adapted for use by a sleep apnea patient to position airway tubes of a nasal interface operatively connected to a positive airway pressure device. The head wear includes an elongated head strap for being worn around a head of the patient. Airway tubes are attached to the head strap, and held by the head strap in a desired position during use, when sleeping.

U.S. Pat. Nos. 6,857,428 and 6,629,532, disclose a retention system for a respiratory mask adapted to engage a patient in a nasal area with flexible, elastic straps coupled to opposing sides of the respiratory mask. As would be known by those skilled in the art, a nasal pillow is used in Continuous positive airway pressure (CPAP) therapy. CPAP is a popularly used treatment for sleep apnea. An example of a nasal pillow is Miragre™ II Nasal Air Pillow System.

A CPAP nasal pillow is an alternative to CPAP face masks. Unlike the mask, which covers the entire nose and mouth and part of the face, a CPAP nasal pillow is attached only to the nostrils, designed to fit in there snugly, through a pair of flared openings. CPAP nasal pillows come with a headgear that is intended to secure the pillow as well as possible, consistent with user comfort and with reducing the likelihood of dislodgement during sleep.

However, conventional headgear for a nasal pillow is constructed to hold the nasal air pillow from its ends, requiring a structure which resists any shifting or twisting movement of the air pillow relative to the user's nostrils and which is displaced from the user's facial contour. When a sleeper is in a sleeping position, lying on a side, the face is no longer upright and is positioned with a side of the face, placed against surface such as a pillow. It is in this side position that the nasal pillow head gear, intended to stabilize the position of the nasal pillow, are forced against the facial contour and the facial soft tissue, causing discomfort and disrupting sleep.

### SUMMARY

This invention is an improved holder for a nasal air pillow. As is known to those skilled in the art, this invention, according to the disclosed inventive principles, is a holder used to enclose the nasal pillow surface along its axial length, on a circumferential locus describing its surface. The holder includes openings for the nasal pillow flared air openings to protrude from the nasal air pillow holder, fitting into the user's nostrils. The holder includes, connecting devices adjacent to the flared openings, shown in a preferred embodiment as connecting rings, fixed to an elastic soft strap, which is configured, for fitting in a curvilinear locus or path from proximate the flared openings, around the user's face and head, thereby providing a stabilizing force directly to the entire surface of the nasal pillow. The tension in the elastic strap is directed along the strap, as would be known to those skilled in the art, to the connecting rings displaced from the flared openings, when inserted into, the user's nostril openings. The curvilinear path of the soft elastic strap, fitted into place around the user's head and stretched producing a tension force, creates a compressive force toward the face and head, placing the length of the soft strap against the user's face and head. That compressive force holds the strap in a substantially contiguous relationship with the surface of the user's face and head, substantially along the length of the soft strap.

The tension in the strap, holds the nasal air pillow holder and nasal air pillow against the users face and nostrils, when in use and the nasal air funnel openings are fitted into the user's nostrils.

As would be known and understood by those skilled in the art, the use of a soft strap, in tension, which is flexible, deformable, would not create any more discomfort that would be felt by the pressure of an ordinary bed pillow, when used to hold the nasal air pillow in place

The soft flexible strap is adapted to conform substantially to the contours of the user's face and direct its force along the user's facial contour. The tension force in the strap is applied from the soft strap at its points of connection to the nasal pillow holder, and from the nasal pillow holder, over the surface of the nasal air pillow.

The force applied by the soft flexible head strap, applied proximate the flared air openings, to the nasal pillow holder is applied over the surface of the nasal pillow, and as, as would be understood by those skilled in the art, provides a level of control over the nasal pillow position when in use, to prevent twisting of the nasal pillow, and pulling the flared openings from the user's nostril, or shifting of the flared air openings relative to the user's nostrils, and displacing the flared openings from the user's nostrils.

### BRIEF DESCRIPTION OF THE DRAWINGS

FIG. 1a shows a preferred embodiment of the nasal air pillow holder in the form of a single sheet, and shown separate and apart from its intended use with a nasal air pillow, as shown in FIGS. 2, 3 and 4.

FIG. 1b shows a two part embodiment of the nasal air pillow holder of FIG. 1a.

FIG. 2a shows the nasal pillow holder of FIG. 1a or 1b, without the holder strap, as shown in FIG. 3 and FIG. 4, as it would appear in an end view when wrapped around itself and held in place by a fastener, for example, VELCRO® strips and holding enclosed within it, a nasal air pillow.

FIG. 2b shows the nasal air pillow holder of FIG. 1a or 1b, with sheet 11, shown instead not as a single sheet, but as a continuous substantially cylindrical sheet, substantially in the form of a cylinder, and without the holder strap, as shown in FIG. 3 and FIG. 4, as it would appear in an end view holding enclosed within it, a nasal air pillow.

FIG. 3 shows the nasal air pillow holder, as shown in FIG. 1a, wrapped around a commercially available nasal air pillow, shown partially in phantom, and with a flexible soft strap, partially shown, attached to the nasal pillow holder connector rings.

FIG. 4 shows in a schematic front view, the nasal air pillow holder, as shown in FIG. 1a, and as used in place, on a user, with the soft head strap substantially in contact with the user's facial and head contour.

### DESCRIPTION OF THE INVENTION

The nasal air pillow holder invention, as shown and described by its inventive principles and in a preferred embodiment, generally designated by numeral 10, is a flexible enclosure sheet shown in a preferred embodiment as a Neoprene® sheet, 11. The sheet 11 is shown in perspective with a thickness dimension 13, a width dimension shown along edge 15, and a length dimension shown along edge 17. The Neoprene® sheet may be replaced by any other suitable flexible material, as would be known to those skilled in the art.

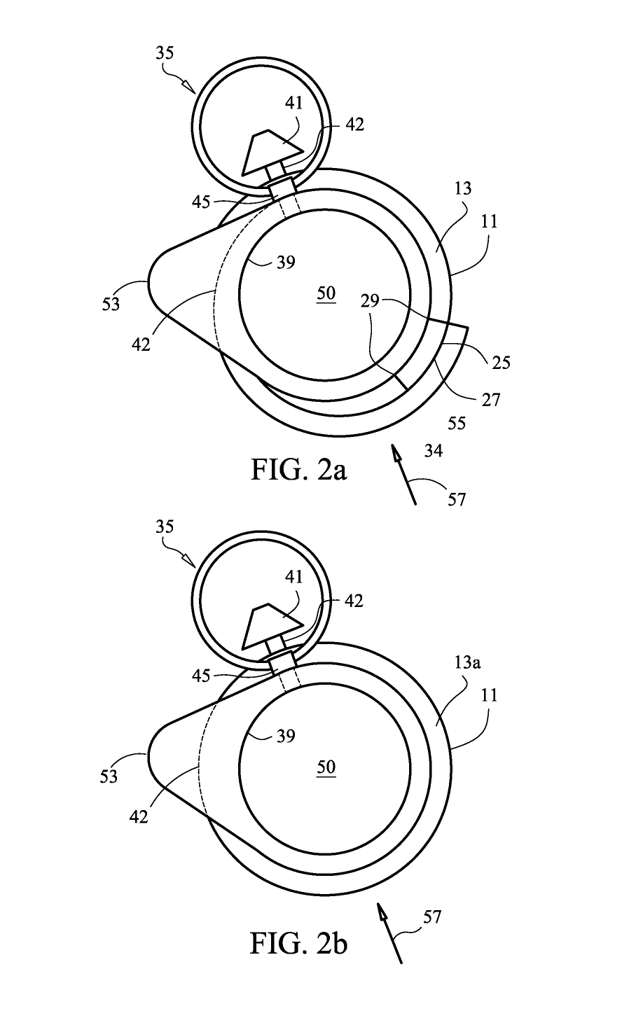

The nasal air pillow holder 10, enclosure sheet 11, is shown with a fastening device for fastening itself, from one side 19 of sheet 11, to the opposite side 21 of sheet 11 in an enclosed relationship, when wrapped around the nasal air pillow 39, as shown in FIGS. 2a, 2b, 3, and 4. The nasal air pillow 39 is a commercially available product and is not part of this disclosed invention. In the preferred embodiment, as shown, and as would be apparent to one skilled in the art, matching Velcro® surfaces 25, shown in phantom on side 21, and surface 27, on side 19, are used to as fastening devices to fasten side 19 on side 21 at overlap area 29 at junction 27, as shown in FIG. 2a.

The nasal air pillow holder sheet 11a, is shown with a length dimension 18, between the fastening devices 27 and 25.

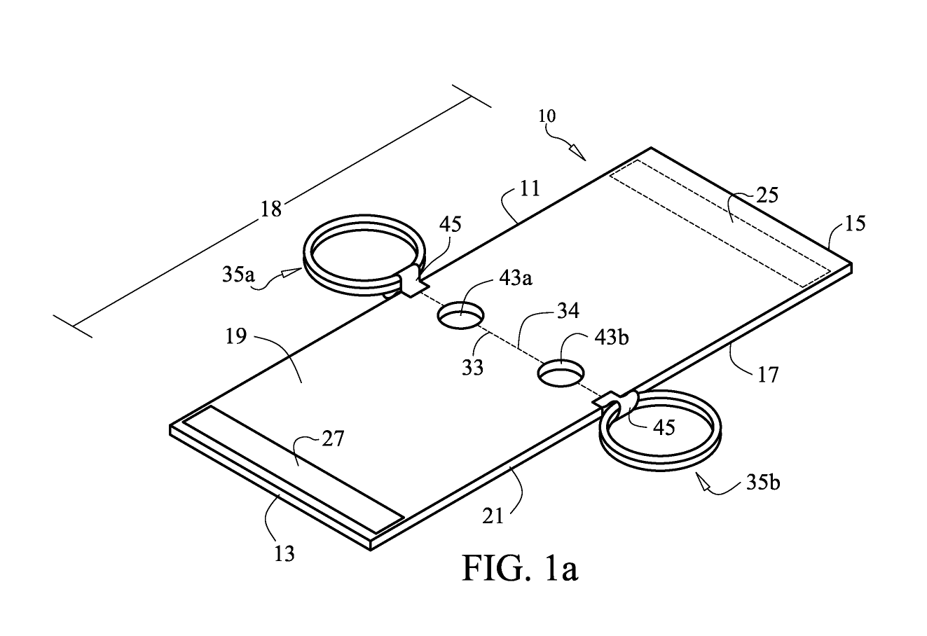

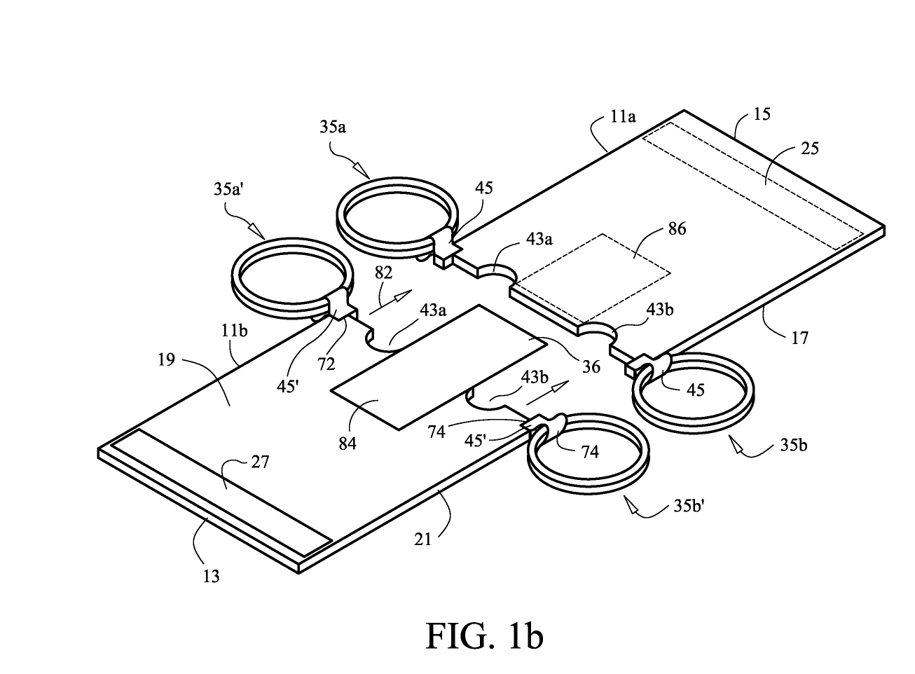

The sheet 11 may be bifurcated as shown in a preferred embodiment in FIG. 1b. As shown in FIG. 1b, the sheet 11 is in two parts 11a and 11b, separated along the line 33, as shown in FIG. 1a, and which is shown passing through the apertures 43a, 43b.

As explained herein, the apertures 43a and 43b, allow the nasal air pillow funnel air openings 41, to protrude through the nasal air pillow holder sheet 11, as shown in FIGS. 2a, 2b, 3, and 4.

Connecting rings 35a and 35b, are shown attached to sheet 11a, by respective clamps 45 for each ring. The clamps may be any suitable clamps, as would be known to those skilled in the art.

In FIG. 1b, the bifurcated sheets 11a and 11b shown in two separated parts, for purpose of explanation, as sheet 11a and 11b. In use, sheet 11a and sheet 11b, would be moved into an abutting relationship, in the direction of arrow 82, in the form of sheet 11 as shown in FIG. 1a.

A set of matching fasteners, shown in a preferred embodiment as fastening tab 36 attached in the area 84 of sheet 11b, and 86, shown on sheet 11a, and opposed to tab 36. Any suitable fastening means could be used for matching fasteners 36, 86, as would be known to those skilled in the art. The fastening means 36 and 86, may be enlarged in its width or length dimension or two or more matching fasteners 36, 86, may be used displaced between the connector rings, shown for explanation on sheet 11b, as 35a′ and 35b′.

Fastening tab 36 may be used to fasten sheet 11b to sheet 11a, as in an abutting relationship, in the form of the single sheet 11, as shown in FIG. 1a, by attachment of tab 34 to area 86 on sheet 11a, using for example by matching fasteners 36, 86, shown in a preferred embodiment as matching VELCRO® surfaces at area 86 and on the opposed underside of tab 36, or by using any other suitable fastening means as would be known to those skilled in the art. As would be apparent to those skilled in the art, any suitable fastener may be used and the invention is not limited to the fastening devices shown or to an overlap area 29, as shown and disclosed in a preferred embodiment.

The connecting rings 35a′ and 35b′, are shown on sheet 11b, for explanation and in a preferred embodiment, are the same rings 35a and 35b, shown as attached to sheet 11a.

In a preferred embodiment, shown for explanation as separate connector ring pairs 35a and 35b and 35a′ and 35b′, the clamps 45′, holding the rings 35a′ and 35b′, are the same clamps as shown by numeral 45 attaching rings 35a and 35b to sheet 11a. In a preferred embodiment, as would be apparent to one skilled in the art, when the bifurcated sheet 11b is moved toward sheet 11a, in the direction of arrows 84, and into an abutting relationship, in the same form or shape as the single continuous sheet, as shown in FIG. 1a, the clamps 45 are attached to the respective opposed corners, 72, 74, of sheet 11b as shown in a preferred embodiment, hidden under the clamps 45′.

In this way, as would be understood by those skilled in the art, and as shown in a preferred embodiment, each connecting ring 35a and 35b is held by respective clamps 45 to sheet 11a and to sheet 11b when in an abutting relationship, as described above.

As would be apparent to those skilled in the art, any suitable fastener device may be used in this invention and the invention is not limited to the fastening device shown or to an overlap area as shown and disclosed in a preferred embodiment. As would be known to those skilled in the art, two or more connector rings may be used for each of the opposed connecting rings 35a and 35b. As would be apparent to those skilled in the art, any suitable fastening device may be used in place of the connecting ring, as would be known to those skilled in the art.

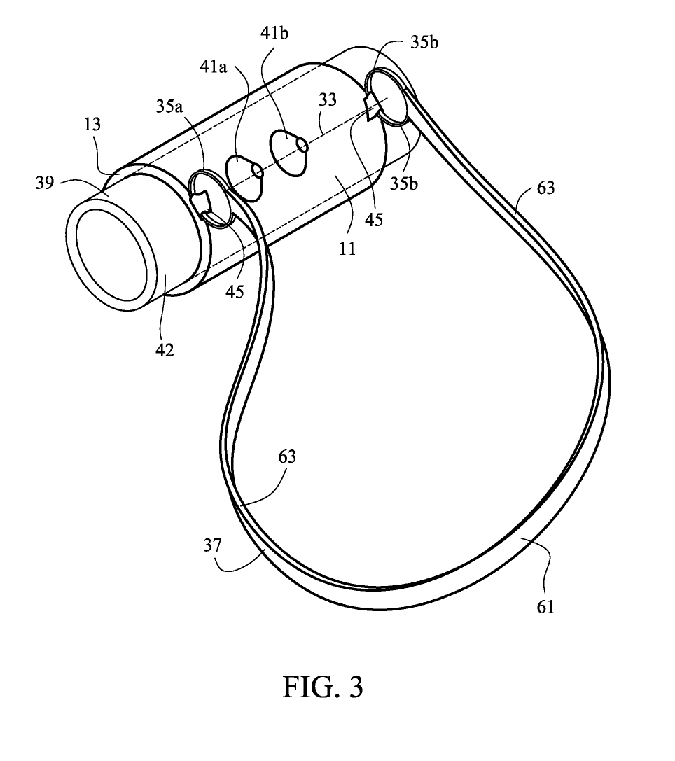

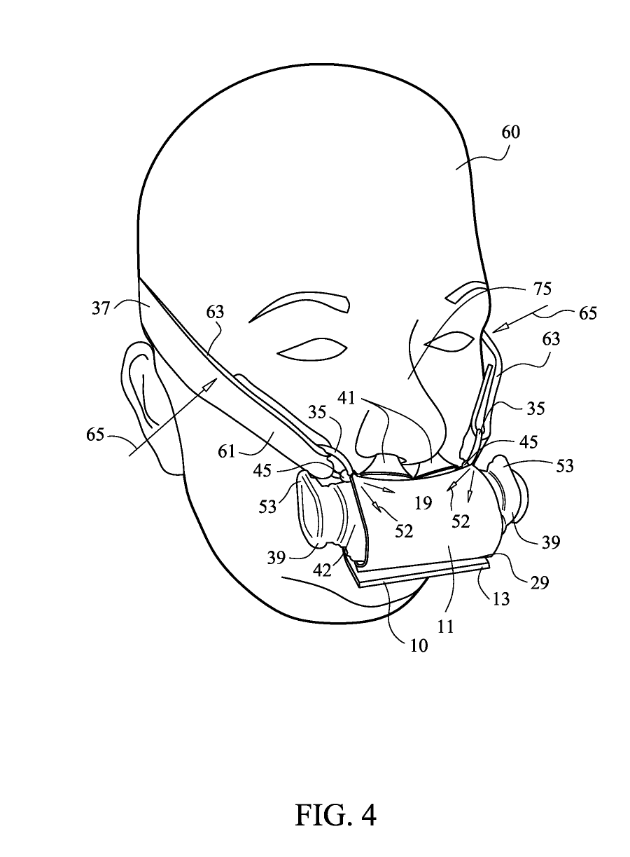

As shown in FIG. 1, there are two spaced apertures 43a and 43b, in the sheet 11, proximate the middle of the length dimension along edge 17 and extending in a line 33, between strap connectors 35a and 35b. Strap connecting rings 35a and 35b, referred to in the following as strap connecting rings or connectors, or connecting rings, 35a and 35b, connecting the strap 37 as shown in FIGS. 3 and 4, may be rings, as shown for a preferred embodiment or may be buckles, or any other suitable strap connector as would be known by those skilled in the art.

FIG. 2a, shows the nasal pillow and holder of FIG. 1, in an end view, without the strap 37, as shown in FIGS. 3 and 4. Sheet 11 is shown from a view toward its thickness dimension 13, wrapped around the nasal pillow 39 and with fastener parts 27 and 25, shown in a preferred embodiment as Velcro® surfaces, joined in overlap area 29.

As shown in a preferred embodiment, as shown in FIGS. 2a and 2b, the curvilinear exterior 42 of the nasal pillow 39 is partially shown in phantom, where hidden by nasal air pillow end cap 53.

In a preferred embodiment, as shown in FIGS. 1a, 2a and 2b, 3 and 4, connector rings 35a and 35b, are shown approximately aligned in FIG. 1a, with line 33, with a mid point 34, and the flared nasal pillow flared air openings 41a and 41b, are shown extending through the nasal air pillow holder apertures 43 to the interior 50 of the nasal air pillow 39.

In a preferred embodiment, the clamps 45, as shown in FIG. 1a, may be placed at any location along the length of the nasal air pillow holder sheet 11, along the length dimension shown along edge 17, or within the shorter length dimension 18 extending substantially between the connecting VELCRO® strips 25, 27. As would be understood by those skilled in the art, the end parts of the length dimension shown along edge 17, are shown included in the overlap area 29, as shown in a preferred embodiment, in FIG. 2a.

As would be known and understood by those skilled in the art, as the connecting rings, 35a and 35b, may be located anywhere along the length dimension shown along edge 17 of sheet 11, the angular displacement position of the connecting rings 35a and 35b, relative to a center or central position opposed to the apertures 43a and 43b, and line 33, as shown in FIG. 1a and FIG. 3, may in a range from 0 degrees to an angular position within the overlap area 29, of plus or minus 180 degrees, as shown with reference to arrow 57, aligned at 180 degrees with the flared nasal air pillow air openings 41. As would be understood by those skilled in the art, where the connectors 35a, 35b, are within the length dimension 18, the angular displacement from the center position or central position aligned with line 33 and apertures 43a and 43b, would be substantially plus or minus 180 degrees, as shown with reference to arrow 57, aligned at 180 degrees with the flared nasal air pillow air openings 41

As would be understood, by those skilled in the art, in a preferred embodiment, where the overlap area 29 is made sufficiently secure, the connector rings 35a and 35b, may be attached to the ends of the sheet 11 length dimension, shown along edge 17, and, within the overlap area 29

In a preferred embodiment, as shown and disclosed in FIG. 2b, the nasal air pillow holder 10, sheet 11, is shown as a continuous substantially cylindrical sheet enclosing nasal air pillow 39 and without any fastening device 25, 27, as shown in FIG. 1a, to fasten the sheet 11, in the disclosed enclosing relationship with the nasal air pillow 39.

FIG. 3 shows the strap 37 for the nasal pillow holder. The strap 37 is shown with a flat or major side dimension 61 and edge or minor side dimension 63. As would be understood to those skilled in the art and as explained below, the tension force produced by the strap 37, when stretched around the user's head 60, as shown in FIG. 4, produce a compressive force in a direction toward the interior of strap 37 and toward the contour of the head of the user 60, as shown by arrow 65, in FIG. 4, directed against the flat or major dimension 61 and against the head and face of the user 60.

Where the strap 37 is in a curvilinear path, as for example when stretched around the user's head 60, as shown in FIG. 4, the force of tension produced in the stretched strap 37, and in the major side direction 61, produces a second compressive force in the direction 65, toward the surface of the user's face and head as shown in FIG. 4. The compressive force inward force is produced as in or with the same effect as an elastic band would produce when stretched around any object, forcing the strap into a substantially contiguous relationship with the contour of the user's face and head 60, substantially along the length of the flat surface 61 of strap 37, as shown in FIG. 4.

The strap 37 may be any suitable elastomeric material enclosed in a soft resilient material, as would be known to those skilled in the art. In a preferred embodiment, the strap 37 is made from Neoprene® stretchable material.

FIG. 4 shows in schematic form, and in a front view, the nasal pillow holder, shown generally by numeral 10, with the nasal air pillow holder sheet 11, as shown in FIG. 1a, wrapped around the nasal air pillow, 39, as shown in FIG. 2a, with flared air openings 41, held in place in the user's nostrils by the soft resilient strap 37. The nasal pillow 39, partially shown in phantom in FIG. 3, is shown in FIG. 4, with the nasal flared air openings 41a and 41b, partially shown placed in the user's nose for breathing communication from an air supply tube, not shown but as would be understood by one skilled in the art.

The strap 37 is made from a resilient elastic material, so any tension force along the flat or major side dimension 61, produces a compressive force in the direction of arrow 65 as when the strap 37 is stretched around the head of the user to hold the nasal pillow 10 in place. As would be known to those skilled in the art, the tension force along the flat or major side dimension 61, would be a spring force proportional to the strap displacement, as it is stretched to fit around the user's head 60. The tension force applied to the connectors 35a and 35b, holds the nasal air pillow, when in use, as shown in FIG. 4, in place against the user's 60, face and nostrils.

As may be seen in FIG. 4, the tension force along the flat surface 61 of the soft strap 37, is extended to the nasal air pillow holder 11 at the point of attachment of strap connector rings 35, shown in a preferred embodiment, proximate the nostrils of nose 75. The tension force of the strap 37, when stretched to fit over or around the user's head 60, is then distributed through the connectors 35, substantially at the location of the connectors 35, and over the surface area of the nasal air pillow holder 10 and the sheet 11, as shown by arrows 52, forcing the nasal air pillow holder 11 and the nasal air pillow 39, into its correct position, where the flared air openings 41a and 41b, are held in the users nose 75 for breathing.

As shown in FIG. 4, a nasal air pillow holder is shown, using a strap 37, held substantially contiguous to the user's 60, face contour, connected to a nasal air pillow enclosure 10 Sheet 11, for holding the nasal air pillow flared air openings 41, and for preventing twisting or shifting of the nasal air pillow relative to a stable breathing position opposed to the user's nostrils.

As shown in FIG. 1a, FIG. 2a, FIG. 3, and FIG. 4, the nasal pillow holder enclosure sheet 11 has a length dimension shown along edge 17 of sheet 11, spaced apertures 43a and 43b, strap connectors 35a and 35b, displaced on sheet 11, proximate the respective spaced apertures, and the sheet 11 encloses the nasal air pillow 39, in a wrapped position.

The curvilinear surface 42, of nasal air pillow 39, is shown in FIGS. 2, 3, and 4.

As disclosed in a preferred embodiment, in FIG. 1a, sheet 11, includes a reference central location 34, on an alignment of the apertures 43a and 43b, as shown by alignment reference line 33.

As shown in FIG. 4, the tension force as shown by arrows 52, from the elastomeric strap 37 when in place on the head 60, of the user, is distributed over and through, the connectors 35 and the surface 19, of said sheet 11 enclosing the nasal air pillow 39.

As shown in a preferred embodiment, in FIG. 3 and FIG. 4, the strap 37 is shown looped through the connecting rings 35a and 35b and back on the surface 61, shown interior of strap 37, relative to its placement around the head 60 of the user. However, as would be known and understood by those skilled in the art, the strap 37 may be looped through connecting rings 35a and 35b, on the outside of strap 37 so the continuous surface of strap 37, in the flat or major side dimension 61, is adjacent to or contiguous, with the head and face of the user 60.

As shown and described, the enclosure means for enclosing a nasal air pillow is shown as the nasal air pillow holder 10 including sheet 11. The aperture means is shown as apertures 43a and 43b.

The connector means for connecting said strap means to said enclosure means substantially adjacent said aperture means is shown as connectors or connecting rings 35a and 35b.

The nasal air pillow enclosure sheet 11 includes fasteners 27 and 25, opposed to each other in the width dimension 15, and positioned on sheet 11 to fasten the sheet in the wrapped position, as shown in FIGS. 2a, 3 and 4.

As shown in FIG. 2a, for example, the nasal air pillow sheet 11, the connectors can be displaced in an angular range from a position in alignment with a center or central location to a position + or −180 degrees, relative to the alignment and said central location.

As shown, in FIG. 4, the nasal air pillow holder 11, holds the air openings 41a and 441b, of the nasal air pillow 39, opposed to the nasal air pillow user's 60 nostrils, as shown in FIG. 4, and prevents twisting or shifting of the nasal air pillow relative to it position opposed to the user's nostrils.

As shown in FIG. 3, are enclosure means 11, for enclosing a nasal air pillow 39,includes aperture means for extending the nasal air pillow air openings through the enclosure means 11, strap means 37, and connector means, 35a and 35b, for connecting the strap means 37, to the enclosure means 11.

The strap means 37 is stretchable for developing a tension force produced in direction along the flat surface 61, of the soft strap 37, for forcing the strap means into a substantially contiguous relationship with the face of the nasal air pillow user 60, from each of the connector means 35a and 35b.

The connector means 35a and 35b, includes means shown as clips 45, for connecting the strap means and its tension force, to the enclosure means 11 and to the the nasal air pillow 39.

The nasal air pillow holder, as shown with the enclosure sheet 11, bifurcated in sheets 11a and 11b, and includes matching fasteners on each said bifurcated sheet, for holding said bifurcated sheets in an abutting relation. As shown, the apertures 43a and 43b, are formed when sheet 11b abuts sheet 11a, where the sheet 11 is bifurcated along a line 33, in alignment with the apertures

As would be apparent to those skilled in the art, modifications may be made to the disclosed preferred embodiment, without departing from the disclosed inventive principles or the equivalent way of operation, or functions, or results achieved.

1. A nasal air pillow holder, using a strap held substantially contiguous to the user's face contour, connected to a nasal air pillow enclosure for holding the nasal air pillow flared air openings and for preventing twisting or shifting of the nasal air pillow relative to a stable breathing position opposed to the user's nostrils, comprising,
a nasal air pillow holder enclosure sheet including a length dimension and width dimension;
said enclosure sheet including spaced apertures for a nasal air pillow air openings;
said enclosure sheet including connectors connected to said sheet across said width dimension; and wherein said sheet encloses said nasal air pillow in a wrapped position.

2. The nasal air pillow holder of claim 1, including fasteners displaced opposed to each other in said length dimension; and positioned on said enclosure sheet to fasten said sheet in said wrapped position around a nasal air pillow.

3. The nasal air pillow of claim 1, wherein said connectors are substantially in alignment, relative to said width dimension, and displaced from said apertures in an angular range from a position in alignment with a center position aligned with said apertures to a position + or −180 degrees, relative to said center position.

4. The nasal air pillow holder of claim 1, including a strap of elastomeric material attached to said connectors and adapted to be stretched in a curvilinear path around the head and face of a nasal air pillow user and to exert a tension force on said strap connectors and a compressive force on said strap toward the interior of said curvilinear path.

5. The nasal air pillow holder of claim 4, wherein said strap is adapted to be held in position by said compressive force substantially in a contiguous relation with the face of a nasal air pillow user.

6. The nasal air pillow holder of claim 5, wherein said contiguous relation extends substantially from, each said connectors.

7. The nasal air pillow holder of claim 6, wherein said tension force is distributed over the surface and through, said nasal air pillow holder enclosure sheet and to the nasal air pillow.

8. The nasal air pillow holder of claim 1, wherein said apertures are substantially in alignment and substantially equally spaced from a midpoint between said apertures.

9. The nasal air pillow holder of claim 1, wherein said enclosure sheet is bifurcated and includes matching fasteners on each said bifurcated sheet, for holding said bifurcated sheets in an abutting relation.

10. The nasal air pillow of claim 9, wherein said matching fasteners includes one or more fasteners on said bifurcated sheets.

11. A nasal air pillow holder for holding the air openings of the nasal air pillow, opposed to the nasal air pillow user's nostrils and for preventing twisting or shifting of the nasal air pillow relative to its position opposed to the user's nostrils, comprising,
Enclosure means for enclosing a nasal air pillow;
said enclosure dimension aperture means for extending the nasal air pillow air openings through said enclosure means;
strap means;
connecting means for connecting said strap means to said enclosure means;
said strap means including tension means for developing a tension force and for forcing
said strap means into a substantially contiguous relationship with the face of the nasal air pillow user.

12. The nasal air pillow holder of claim 11, wherein said enclosure means includes fastening means for holding said enclosure means when wrapped around said nasal air pillow and.

13. The nasal air pillow holder of claim 11, wherein, said enclosure means includes a width dimension and said aperture means are substantially aligned in said width dimension, said connecting means for connecting said strap means to said enclosure means are displaced in a substantially opposed relation relative to said width dimension, and in a angular range from a central position aligned with said apertures to a position + or −180 degrees from said central position.

14. The nasal air pillow holder of claim 11, wherein, said tension means for forcing said strap means into a substantially contiguously relationship with the face of the nasal air pillow user, include means for forcing said strap means into said substantially contiguous relationship, from each said connecting means.

15. The nasal air pillow holder of claim 11, wherein said enclosure means includes a surface means and said means for connecting said tension force to said enclosure means, includes means for applying said tension force to said surface means and through said enclosure means to a nasal air pillow.

16. The nasal air pillow holder of claim 11, wherein said enclosure means is bifurcated into two parts along a line passing through said aperture means and including fastening means to fasten said bifurcate parts in an abutting relationship.

17. A method of holding a nasal air pillow in place with the nasal air pillow air openings disposed in opposition to nostrils of a nasal air pillow user, comprising the steps of, enclosing a nasal air pillow in a nasal air pillow holder sheet, with the nasal air pillow air openings apertures extending through apertures in said nasal air pillow holder sheet;
connecting an elastomeric strap to said nasal air pillow holder;
placing said nasal air pillow with the nasal air pillow air openings opposed to the nostrils of the nasal air pillow user;
placing said elastomeric strap in tension on the head of a of a user, in a curvilinear path and into substantially contiguous contact with the face of the nasal air pillow user.

18. The method of claim 17, wherein the step of connecting an elastomeric strap, includes the step of connecting said elastomeric strap in a range from a central position in alignment with said apertures to a position + or −180 degrees from said central position.

19. The method of claim 17, including the step of enclosing a nasal air pillow in a bifurcated nasal air pillow sheet.

20. The method of claim 19, including the step of fastening said one of said bifurcated sheets to the other of said bifurcated sheets, in an abutting relationship, aligned with said nasal pillow holder apertures.
